(19) United States
(12) Patent Application Publication
(10) Pub. No.: US 2025/0300982 A1
(43) Pub. Date: Sep. 25, 2025

(54) ACCESSING NON-COLLOCATED DATA CORRESPONDING TO A DETECTED MOBILE APPARATUS

(71) Applicant: Truist Bank, Charlotte, NC (US)

(72) Inventor: Schae Allante Dodd, Charlotte, NC (US)

(73) Assignee: Truist Bank, Charlotte, NC (US)

(21) Appl. No.: 18/609,577

(22) Filed: Mar. 19, 2024

(51) Int. Cl. H04L 9/40; G06Q 40/02

(52) U.S. Cl. CPC H04L 63/10; G06Q 40/02

(57) ABSTRACT

A system and a method for detecting presence of a mobile apparatus, such as a bank card, at a mobile apparatus terminal and accessing non-collocated data based thereon. A computer terminal non-collocated with the mobile device terminal is in operative communication with the mobile apparatus terminal across a communication channel. The computer terminal includes a display screen. A processor and a storage device are operatively coupled with both terminals across the communication channel. An application stored in the storage device includes executable code that is executed by the processor to: operate the mobile apparatus terminal to detect a presence of the mobile apparatus, read information stored thereon and transform the information into identification data; generate display data by processing the identification data; and use the display data to generate on the display screen a display associated with the mobile apparatus.

### FIELD

This invention relates generally to the field of personal identification by computing systems, and more particularly embodiments of the invention relate to presenting a mobile apparatus to a mobile apparatus reader terminal to automatically and securely identify a user to an agent of an enterprise computing system.

### BACKGROUND

User devices, such as bank credit cards and bank debit cards, enable users to efficiently transfer funds from their accounts. A user device can be electronically linked to an account or accounts belonging to the user. The user device can be a means of authenticating the user. Users can have only limited control over the operation of the user devices during transactions.

Early user devices were plastic cards that had a magnetic stripe to store account information which was read by a magnetic stripe reader at a point of sale (“POS”) terminal. The magnetic stripe reader would read information including an account number from the magnetic stripe, and then communicate the information to a network for processing by one or more computing systems.

More recently, user devices that incorporate an integrated circuit (“IC”) have been utilized. Some of these user devices are “contactless” devices that communicate with a user device reader via wireless radio frequency (“RF”) communication.

In a typical transaction involving a contactless user device, the device is presented to a contactless reader associated with a terminal (such as a POS terminal) in a so called “tap” movement. An interrogation process ensues in which the user device exchanges data with the reader. Persons who are in a hurry find the contactless user device to be faster in completing a transaction than using a magnetic stripe reader.

In a bank environment, an existing user approaches an agent and provides identification information. The agent inputs the identification information into a computer terminal connected to the bank computing system. The computing system uses the user information to search stored records and then displays the identity of the user to the agent on the screen of the computer terminal. This procedure is a pain point for users because they do not enjoy providing their identification information in front of other users in the bank branch. Also transaction times are increased as are waiting times for other users in line.

### BRIEF SUMMARY

Embodiments of the present invention address the above needs and/or achieve other advantages by providing systems and methods that enable a user to be identified to an agent through a computerized system.

An embodiment of the invention includes a system for detecting presence of a mobile apparatus and accessing non-collocated data based thereon, the system comprising: a mobile apparatus terminal; a computer terminal non-collocated with the mobile apparatus terminal and in operative communication with the mobile apparatus terminal across a communication channel, the computer terminal having a display screen; a processor and a storage device operatively coupled with the mobile apparatus terminal and with the computer terminal across the communication channel; and an application stored in the storage device and including executable code that, when executed causes the processor to operate both the mobile apparatus terminal and the non-collocated computer terminal by: operating the mobile apparatus terminal to detect a presence of the mobile apparatus; operating the mobile device terminal to read information stored on the mobile apparatus presented to the mobile apparatus terminal and to transform the information into identification data; generating display data by processing the identification data; and using the display data to generate on the display screen a display associated with the mobile apparatus.

The system processor can be included in the computer terminal or is included in a computing system that is in communication with the computer terminal. The system storage device can be included in the computer terminal or is included in a computing system that is in communication with the computer terminal.

The information can identify a user of the mobile apparatus and the display identifies the user of the mobile apparatus.

The mobile apparatus terminal is adapted to read the information stored at a magnetic stripe and/or a contactless communication interface on the mobile apparatus. The mobile apparatus can be a bank issued card such as a credit card or a debit card.

The computer terminal can be an agent computer terminal in communication with a bank computing system. The mobile apparatus can be a bank card, the mobile apparatus terminal can be adapted to read the information stored at a contactless communication interface on the bank card and the computer terminal is in communication with the computing system of the bank that issued the bank card.

The executed code causes the processor to compare the identification data with data stored in a computing system that is in communication with the computer terminal to complete the identification data and/or to verify the identification data.

An embodiment of the invention includes a method for detecting presence of a mobile apparatus and accessing non-collocated data based thereon, the method comprising steps of: providing a mobile apparatus terminal, a computer terminal non-collocated with the mobile apparatus terminal and in operative communication with the mobile apparatus terminal across a communication channel, the computer terminal having a display screen, a processor and a storage device operatively coupled with the mobile apparatus terminal across the communication channel, and an application stored in the storage device and including executable code that is executed by the processor to control the following steps: operating the mobile apparatus terminal to detect a presence of the mobile apparatus; operating the mobile apparatus terminal to read information stored on a mobile apparatus presented to the mobile apparatus terminal and to transform the information into identification data; generating display data by processing the identification data; and using the display data to generate on the display screen a display associated with the mobile apparatus.

The processor can be included in the computer terminal or in a computing system that is in communication with the computer terminal. The storage device can be included in the computer terminal or in a computing system that is in communication with the computer terminal.

The application can be activated when the computer terminal is first turned on or by the computer terminal.

The mobile apparatus terminal reads the information that is stored at a magnetic stripe or a contactless communication interface on the mobile apparatus. The mobile apparatus can be issued by a bank. The computer terminal is in communication with a computing system of a bank that issued the mobile apparatus.

The mobile apparatus can be a bank card, the mobile apparatus terminal reads the user information stored at a contactless communication interface on the bank card and the computer terminal is in communication with a computing system of a bank that issued the bank card.

The method includes comparing the identification data with data stored in a computing system in communication with the computer terminal to complete the identification data and/or to verify the identification data.

Another embodiment of the invention includes a method for detecting presence of a bank card and accessing non-collocated data based thereon, the method comprising steps of: providing a bank card terminal, a computer terminal non-collocated with the bank card terminal and in operative communication with the bank card terminal across a communication channel, the computer terminal having a display screen, a processor and a storage device operatively coupled with the bank card terminal across the communication channel, and an application stored in the storage device and including executable code that is executed by the processor to control the following steps: operating the bank card terminal to detect a presence of the bank card; operating the bank card terminal to read information stored on a bank card presented to the bank card terminal and to transform the information into identification data; generating display data by processing the identification data; and using the display data to generate on the display screen an identity display associated with the bank card.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates an enterprise system, and environment thereof, according to at least one embodiment.

FIG. 2 is a front view of a mobile apparatus according to at least one embodiment of the invention.

FIG. 3 is a back view of the mobile apparatus shown in FIG. 2.

FIG. 4 is a block diagram of a system for performing a method according to at least one embodiment of the invention.

FIG. 5 is a flow diagram representing a method, according to at least one embodiment, of using the mobile apparatus shown in FIG. 2 and FIG. 3 and the system shown in FIG. 4 according to an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

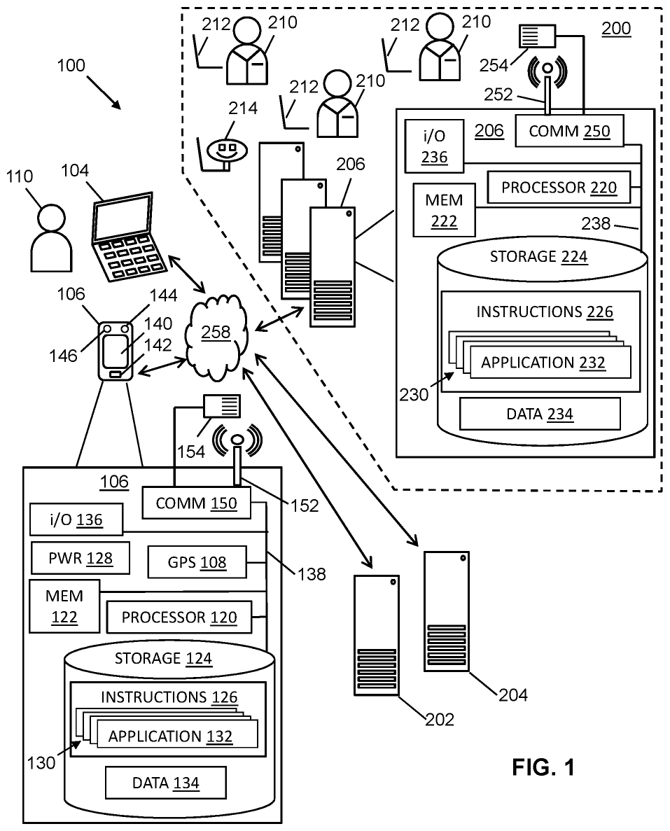

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P transaction system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system user application from a mobile banking system, for example enterprise system 200, or from a distinct application server. In other embodiments, the user 110 interacts with a mobile banking system via a web browser application in addition to, or instead of, the mobile P2P transaction system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include an interface. The network interface may include software, such as encryption software, and hardware, such as a modem, for communicating information to and/or from one or more devices on a network. For example, the mobile device 106 may be configured so that it can be used as a user device by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, account cards, automatic-teller machines, loans, mortgages, personal accounts, business accounts, account management, and credit reporting, requests and scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent transaction clearinghouse or transaction rail systems for processing transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

Most people are familiar with payment devices, such as credit cards, bank cards, stored value cards, or the like. Payment devices enable users to efficiently transfer funds. A payment device may be electronically linked to an account or accounts belonging to the user. The payment device may be a means of authenticating the user. For quite some time, most payment devices had a magnetic stripe to store user information that could be read by a magnetic stripe reader at a point of sale (“POS”) terminal. The magnetic stripe reader would read information including an account number from the magnetic stripe, and then communicate the information to a network for processing. More recently, payment devices that incorporate an integrated circuit (“IC”) have been utilized. Some of these payment devices are “contactless” devices that communicate with a device reader via wireless radio frequency (“RF”) communication.

In a typical transaction involving a contactless payment device, the device is presented to a contactless reader associated with a terminal (such as a POS terminal). An interrogation process ensues in which the payment device exchanges data with the reader. Persons who are in a hurry find the contactless payment device to be faster in completing a transaction than using a magnetic stripe reader.

In a bank environment, an existing user approaches a bank agent and provides identification information orally or by showing a document. The agent inputs the identification information into a computer terminal connected to the bank computing system. The computing system uses the user information to search stored records and then displays the identity of the user to the agent on the screen of the computer terminal. This procedure is a pain point for users because they do not enjoy providing their identification information in front of other users in the bank branch. Also transaction times are increased as are waiting times for other users in line.

A method and a system according to the invention use a contactless mobile apparatus, such as a bank card, and a contactless mobile apparatus terminal, such as a card terminal, to reduce transaction and waiting times for users and bank agents. The method and the system also work using the mobile apparatus magnetic stripe and a magnetic stripe reader of the mobile apparatus terminal. The method and the system are described below with reference to one embodiment wherein the mobile apparatus is a bank mobile apparatus, the user is a holder of the mobile apparatus and the agent is an agent of the bank such as a bank teller.

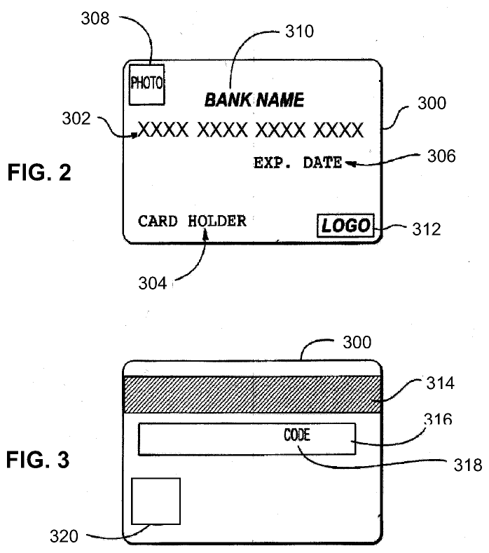

There is shown in FIG. 2 a front side of a typical bank mobile apparatus 300, such as a credit card or a debit card, according to at least one embodiment of the invention. A rear or back side of the mobile apparatus 300 is shown in FIG. 3. As is typical, the mobile apparatus 300 is provided on the front side with raised account numbers 302, the account holder name 304, the expiration date 306, and a photo of the holder and/or hologram 308. The mobile apparatus 300 also might include the issuing bank name 310 and/or the issuing bank logo 312. A magnetic stripe 314 is provided on the rear of the mobile apparatus 300. The magnetic stripe includes data fields for specific information such as account number, country code, surname, first name or initial, middle name or initial, title, expiration date, etc. Below the stripe is a signature area 316 being a surface suitable for the holder to sign in ink and including a three or four digit authentication code 318. A contactless communication interface 320 is shown on the back side of the mobile apparatus 300, but the interface can be provided on the front side of the mobile apparatus. The magnetic stripe 314 can communicate with a mobile apparatus terminal having a magnetic stripe reader and the contactless communication interface can communicate with a contactless mobile apparatus reader of a mobile apparatus terminal.

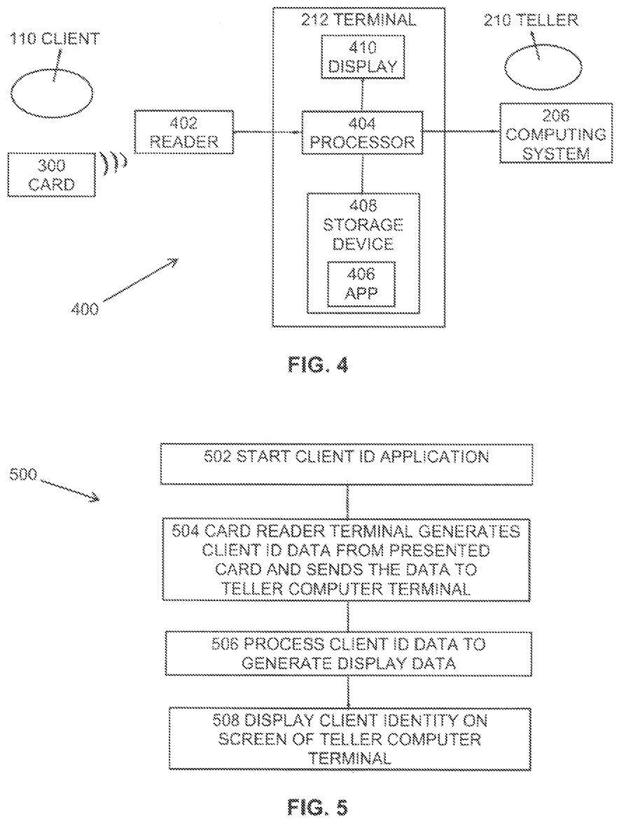

FIG. 4 is a block diagram of a system 400 for performing a method according to at least one embodiment of the invention. A user 110, being a client of a financial institution such as a bank, carries the mobile apparatus 300 (card) issued by the bank. In order to conduct business, the user 110 approaches a human agent 210, such a bank teller or service representative, located at an agent device 212, such as a computer terminal. The computer terminal 212 is in communication with the bank computing system 206 and with a mobile apparatus terminal 402 (card reader) accessible by the user 110. The computer terminal 212 includes a processor 404, similar to the processors 120 and 220 shown in FIG. 1, that is executing an application 406 stored in a storage device 408 of the terminal 212. As an alternative, the application can be stored in the storage device 224 of the computing system 206 and executed by the processor 220.

Upon approaching the agent 210, the user 110 presents the mobile apparatus 300 to the mobile apparatus terminal (reader) 402. The terminal 402 detects the presence of the mobile apparatus 300 and, either by reading from the contactless communication interface 320 or by reading the magnetic stripe 314, reads the stored information and transforms that information into identification data. The application 406 processes the identification data to generate display data. The computer terminal 212 uses the display data to generate on the display screen 410 a display associated with the mobile apparatus such as the name 304 and the account number 302. The application 406 can communicate with the computing system 206 as required to obtain additional information about the user 110 and/or verify the identity of the user before generating the display.

FIG. 5 is a flow diagram representing a method 500, according to at least one embodiment, of using the mobile apparatus 300 shown in FIGS. 2 and 3 with the system 400 shown in FIG. 4 according to an embodiment of the invention. The method 500 starts with a step 502 of activating the application 406. The activation can be done when the computer terminal 212 is turned on, or can be initiated by the agent 210 using the computer terminal 212 as the user 110 approaches. In a step 504, the mobile apparatus terminal 402 detects the presence of the mobile apparatus 300, reads information stored on the mobile apparatus, and transforms the information into identification data. As explained above, the mobile apparatus terminal 402 is used either to read the magnet stripe 314 or to communicate with the contactless communication interface 320.

In a step 506, the application 406 causes the identification data to be processed into display data that is used to generate a display (user/client identity) on the display screen 410 in a step 508. The application 406 can control the computer terminal 212 to communicate with the storage device 224 of the computing system 206 to compare the identification data with the other data 234 to complete and/or verify the identification data.

Prior to the first time that each user 110 users the system 400 and the method 500, the agent 210 can explain the procedure and the benefits of such use. Thereafter the user 110 will know to present his/her mobile apparatus 300 to the mobile apparatus terminal 402 to reduce the transaction time. The system 400 and the method 500 also reduce the waiting times for other users in line at the agent 210. Although the system and the method according to the invention are described in terms of a bank enterprise system, they can be applied to any enterprise system that processes mobile apparatuses and requires transactions involving interaction between a user and an agent.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A system for detecting presence of a mobile apparatus and accessing non-collocated data based thereon, the system comprising:
a mobile apparatus terminal;
a computer terminal non-collocated with the mobile apparatus terminal and in operative communication with the mobile apparatus terminal across a communication channel, the computer terminal having a display screen;
a processor and a storage device operatively coupled with the mobile apparatus terminal and with the computer terminal across the communication channel; and
an application stored in the storage device and including executable code that, when executed causes the processor to operate both the mobile apparatus terminal and the non-collocated computer terminal by:
operating the mobile apparatus terminal to detect a presence of the mobile apparatus;
operating the mobile device terminal to read information stored on the mobile apparatus presented to the mobile apparatus terminal and to transform the information into identification data;
generating display data by processing the identification data; and
using the display data to generate on the display screen a display associated with the mobile apparatus.

2. The system according to claim 1 wherein the processor is included in the computer terminal or is included in a computing system that is in communication with the computer terminal.

3. The system according to claim 1 wherein the storage device is included in the computer terminal or is included in a computing system that is in communication with the computer terminal.

4. The system according to claim 1 wherein the information identifies a user of the mobile apparatus.

5. The system according to claim 4 wherein the display identifies the user of the mobile apparatus.

6. The system according to claim 1 wherein the mobile apparatus terminal is adapted to read the information stored at a magnetic stripe and/or a contactless communication interface on the mobile apparatus.

7. The system according to claim 6 wherein the mobile apparatus is a bank issued card.

8. The system according to claim 1 wherein the computer terminal is an agent computer terminal in communication with a bank computing system.

9. The system according to claim 1 wherein the mobile apparatus is a bank card, the mobile apparatus terminal is adapted to read the information stored at a contactless communication interface on the bank card and the computer terminal is in communication with a computing system of a bank that issued the bank card.

10. The system according to claim 1 wherein the executed code causes the processor to compare the identification data with data stored in a computing system that is in communication with the computer terminal to complete the identification data and/or to verify the identification data.

11. A method for detecting presence of a mobile apparatus and accessing non-collocated data based thereon, the method comprising steps of:
providing a mobile apparatus terminal, a computer terminal non-collocated with the mobile apparatus terminal and in operative communication with the mobile apparatus terminal across a communication channel, the computer terminal having a display screen, a processor and a storage device operatively coupled with the mobile apparatus terminal across the communication channel, and an application stored in the storage device and including executable code that is executed by the processor to control the following steps:
operating the mobile apparatus terminal to detect a presence of the mobile apparatus;
operating the mobile apparatus terminal to read information stored on a mobile apparatus presented to the mobile apparatus terminal and to transform the information into identification data;
generating display data by processing the identification data; and
using the display data to generate on the display screen a display associated with the mobile apparatus.

12. The method according to claim 11 including wherein the processor is included in the computer terminal or in a computing system that is in communication with the computer terminal.

13. The method according to claim 11 wherein the storage device is included in the computer terminal or in a computing system that is in communication with the computer terminal.

14. The method according to claim 11 including activating the application when the computer terminal is first turned on or by the computer terminal.

15. The method according to claim 11 wherein the mobile apparatus terminal reads the information that is stored at a magnetic stripe or a contactless communication interface on the mobile apparatus.

16. The method according to claim 11 wherein the mobile apparatus is issued by a bank.

17. The method according to claim 16 wherein the computer terminal is in communication with a computing system of a bank that issued the mobile apparatus.

18. The method according to claim 11 wherein the mobile apparatus is a bank card, the mobile apparatus terminal reads the user information stored at a contactless communication interface on the bank card and the computer terminal is in communication with a computing system of a bank that issued the bank card.

19. The method according to claim 11 including comparing the identification data with data stored in a computing system in communication with the computer terminal to complete the identification data and/or to verify the identification data.

20. A method for detecting presence of a bank card and accessing non-collocated data based thereon, the method comprising steps of:
providing a bank card terminal, a computer terminal non-collocated with the bank card terminal and in operative communication with the bank card terminal across a communication channel, the computer terminal having a display screen, a processor and a storage device operatively coupled with the bank card terminal across the communication channel, and an application stored in the storage device and including executable code that is executed by the processor to control the following steps:
operating the bank card terminal to detect a presence of the bank card;
operating the bank card terminal to read information stored on a bank card presented to the bank card terminal and to transform the information into identification data;
generating display data by processing the identification data; and
using the display data to generate on the display screen an identity display associated with the bank card.
